(19) United States
(12) Patent Application Publication
(10) Pub. No.: US 2013/0169790 A1
(43) Pub. Date: Jul. 4, 2013

(54) OPTICAL CHARACTERISTICS CAPTURING APPARATUS AND METHOD FOR INSPECTING OPTICAL CHARACTERISTICS OF A FLEXIBLE DISPLAY

(71) Applicants: Bo-Wen Xiao, Taoyuan County (TW); Sheng-Po Wang, Taoyuan County (TW); Min-Yao Lu, Taichung City (TW)

(72) Inventors: Bo-Wen Xiao, Taoyuan County (TW); Sheng-Po Wang, Taoyuan County (TW); Min-Yao Lu, Taichung City (TW)

(73) Assignee: INDUSTRIAL TECHNOLOGY RESEARCH INSTITUTE, Hsinchu (TW)

(21) Appl. No.: 13/434,873

(22) Filed: Mar. 30, 2012

(30) Foreign Application Priority Data
Dec. 28, 2011 (TW) 100149278

(51) Int. Cl. H04N 7/18

(52) U.S. Cl. 348/92; 348/E07.085

(57) ABSTRACT

An optical characteristics capturing apparatus includes an adjustable stage for carrying the flexible display, an image capturing device disposed above the adjustable stage, and two first collimated light sources. A part of the flexible display forms a curved surface. An intersection of a receiving optical axis of the image capturing device and the curved surface of the flexible display is an intersection point. The two first collimated light sources project two dot-patterns onto the intersection point along two first optical paths having identical length but different extending directions. An included angle between each of the two first optical paths and the receiving optical axis is an acute angle. The two first optical paths and the receiving optical axis are located in a first virtual plane.

### CROSS-REFERENCE TO RELATED APPLICATION

This application claims the priority benefit of Taiwan application serial no. 100149278, filed on Dec. 28, 2011. The entirety of the above-mentioned patent application is hereby incorporated by reference herein and made a part of this specification.

### BACKGROUND

1. Field of the Application

The application relates to an optical characteristics capturing apparatus (OCC apparatus), and particularly relates to an OCC apparatus capable of inspecting optical characteristics of flexible displays rapidly.

2. Description of Related Art

To meet the life of modern people, flat panel displays have become a mainstream of displays on the market. At present, the major types of flat panel displays include plasma display panels (PDP), liquid crystal displays (LCD), organic electro-luminescence displays (OEL displays), and electronic-ink displays, etc. Currently, most of flat panel displays has no flexibility. With an advancement of display industries, flat panel displays with flexibility have gradually become the mainstream of the next generation.

In order to inspect optical characteristics of bended flexible display panels, a three dimensional coordinates measuring machine apparatus (CMM apparatus) is used to inspect the outer profile of flexible display panels. Accordingly, the winding condition of each and every location of flexible display panels is obtained by the CMM apparatus in advance. Then, coordinates apparatus of the CMM apparatus and the OCC apparatus are synchronized. Based on the information obtained from the CMM apparatus, the optical characteristics of an inspecting area of flexible display panels is inspected by the OCC apparatus correctly. Generally, the OCC apparatus is disposed to inspect the optical characteristics of the inspecting area along a normal direction of the inspecting area.

Before the optical characteristics of an inspecting area of flexible display panels is inspected by the OCC apparatus, the outer profile of flexible display panels must be obtained by the CMM apparatus. Since the measuring steps performed by the CMM apparatus and the OCC apparatus are complicated and time consuming, prior art is not capable of inspecting optical characteristics of flexible displays rapidly.

### SUMMARY

The application provides an optical characteristic capturing apparatus (OCC apparatus) capable of inspecting optical characteristics of flexible displays rapidly.

The application provides an OCC apparatus including an adjustable stage, an image capturing device and two first collimated light sources. The adjustable stage is suitable for carrying a flexible display, wherein a part of the flexible display forms a curved surface. The image capturing device is disposed above the adjustable stage and an intersection of a receiving optical axis of the image capturing device and the curved surface of the flexible display is an intersection point. The two first collimated light sources project two first dot-patterns onto the intersection point along two first optical paths having identical length but different extending directions. An included angle between each of the two first optical paths and the receiving optical axis is an acute angle. The two first optical paths and the receiving optical axis are located in a first virtual plane.

The application provides another OCC apparatus including an adjustable stage, an image capturing device, a collimated light source and a rotator. The adjustable stage is suitable for carrying a flexible display, wherein a part of the flexible display forms a curved surface. The image capturing device is disposed above the adjustable stage, and an intersection of a receiving optical axis of the image capturing device and the curved surface of the flexible display is an intersection point. The rotator is connected to the collimated light source and drives the collimated light source to rotate around the receiving optical axis, such that the collimated light source projects two first dot-patterns onto the intersection point along two first optical paths having identical length but different extending directions. An included angle between each of the two first optical paths and the receiving optical axis is an acute angle. The two first optical paths and the receiving optical axis are located in a first virtual plane.

The application further provides a method for inspecting optical characteristics of a flexible display. First of all, a flexible display is provided and disposed above an adjustable stage, wherein a part of the flexible display forms a curved surface. Then, an image capturing device and two first collimated light sources are provided, wherein the image capturing device is disposed above the adjustable stage and an intersection of a receiving optical axis of the image capturing device and the curved surface of the flexible display is an intersection point. In addition, the two first collimated light sources project two first dot-patterns onto the intersection point along two first optical paths having identical length but different extending directions. An included angle between each of the two first optical paths and the receiving optical axis is an acute angle. The two first optical paths and the receiving optical axis are located in a first virtual plane. Thereafter, a normal direction of the intersection point is adjusted by the adjustable stage until the two first dot-patterns projected onto the intersection point and captured by the image capturing device are substantially identical.

In order to make the aforementioned and other features and advantages of the application more comprehensible, embodiments accompanying figures are described in detail below.

### BRIEF DESCRIPTION OF THE DRAWINGS

The accompanying drawings constituting a part of this specification are incorporated herein to provide a further understanding of the application. Here, the drawings illustrate embodiments of the application and, together with the description, serve to explain the principles of the application.

FIG. 1A and FIG. 1B are schematic views illustrating an OCC apparatus according to the first embodiment of the application.

FIG. 2 is a schematic view illustrating an OCC apparatus according to the second embodiment of the application.

FIG. 3 is a schematic view illustrating an OCC apparatus according to the third embodiment of the application.

FIG. 4 is a schematic view illustrating an OCC apparatus according to the fourth embodiment of the application.

FIG. 5 is a schematic view illustrating an OCC apparatus according to the fifth embodiment of the application.

### DESCRIPTION OF EMBODIMENTS

### First Embodiment

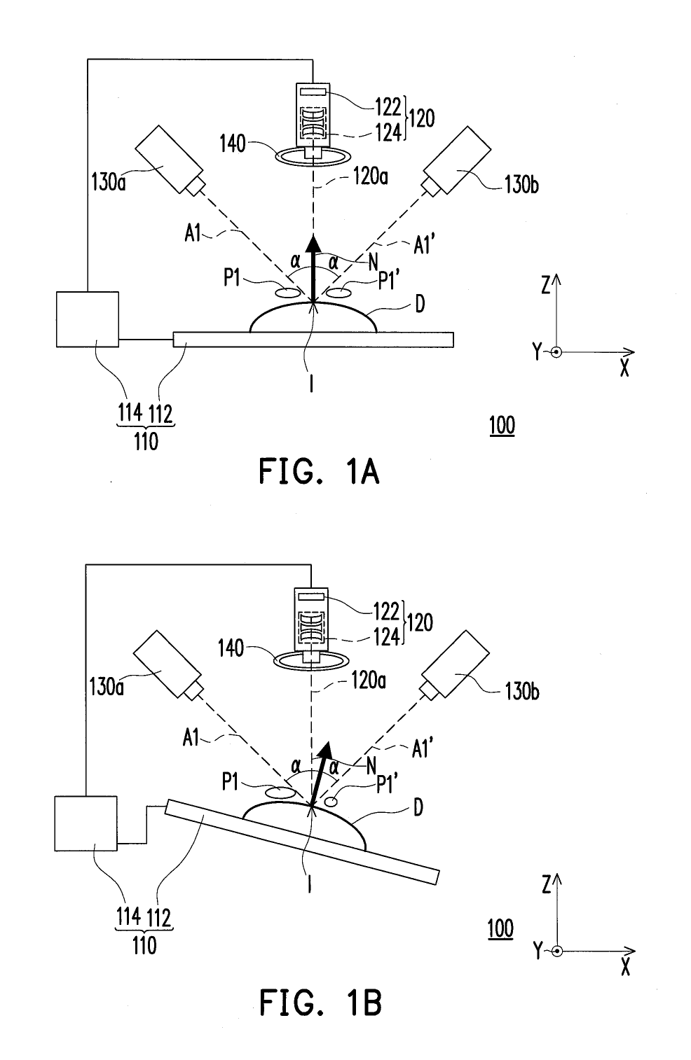

FIG. 1A and FIG. 1B are schematic views illustrating an OCC apparatus according to the first embodiment of the application. Referring to FIG. 1A and FIG. 1B, the OCC apparatus 100 of this embodiment is suitable for inspecting optical characteristics of a flexible display D. For example, the optical characteristics of a flexible display D include transmittance, reflectivity, brightness, spectrum, color and other optical information. In this embodiment, the flexible display D includes a plasma display panels (PDP), a liquid crystal displays (LCD), an organic electro-luminescence displays (OEL displays), an electronic-ink displays and so on. Certainly, other types of flexible displays can also be used in this application. It is noted that a part of the flexible display D may be bended and form a curved surface.

As shown in FIG. 1A and FIG. 1B, the OCC apparatus 100 of this embodiment includes an adjustable stage 110, an image capturing device 120, and two first collimated light sources 130a and 130b. The adjustable stage 110 is suitable for carrying the flexible display D. The image capturing device 120 is disposed above the adjustable stage 110, and an intersection of a receiving optical axis 120a of the image capturing device 120 and the curved surface of the flexible display D is an intersection point I. The two first collimated light sources 130a, 130b project two first dot-patterns P1, P1′ onto the intersection point I along two first optical paths A1, A1′having identical length but different extending directions. An included angle between each of the two first optical paths A1, A1′ and the receiving optical axis 120a is an acute angle α. The two first optical paths A1, A1′ and the receiving optical axis 120a are located in a first virtual plane. In this embodiment, the above-mentioned first virtual plane is parallel with X-Z plane.

In this embodiment, the adjustable stage 110 includes a stage 112 and a controller 114, wherein the stage 112 is suitable for carrying the flexible display D, and the controller 114 is electrically connected to the image capturing device 120 and the stage 112. The controller 114 controls the movement of the stage 112 until the two first dot-patterns P1′, P1′ projected onto the intersection point I and captured by the image capturing device 120 are substantially identical. In addition, the stage 112 is, for example, a six-axes rotatable stage. In this embodiment, through the driving of the controller 114, the stage 112 is capable of adjusting the normal direction N of the intersection point I of the flexible display D. Generally, the normal direction N of the intersection point I of the flexible display D is located in the first virtual plane that is parallel with X-Z plane. In other words, the normal direction N, the two first optical paths A1, A1′ and the receiving optical axis 120a are located in the above-mentioned first virtual plane.

The image capturing device 120 includes a photo-sensor 122 and a lens 124, wherein the lens 124 is between the photo-sensor 122 and the adjustable stage 110, and the receiving optical axis 120a of the image capturing device 120 is defined by the lens 124.

In this embodiment, the major function of the two first collimated light sources 130a, 130b is to assist in positioning of the flexible display D, such that the normal direction N of the intersection point I of the flexible display D can coincide with the receiving optical axis 120a of the image capturing device 120 rapidly. Specifically, each of the two first collimated light sources 130a, 130b is, for example, a visible light source with collimating lens or a pin-hole laser.

In this embodiment, the normal direction N of the intersection point I of the flexible display D is adjusted by the adjustable stage 110 to coincide with the receiving optical axis 120a of the image capturing device 120. During the adjustment, the two first dot-patterns P1, P1′ are always captured by the image capturing device 120 until the two first dot-patterns P1, P1′ captured by the image capturing device 120 are substantially identical (as shown in FIG. 1A).

Since the two first collimated light sources 130a, 130b are symmetrically disposed at two opposite sides of the receiving optical axis 120a, the two first dot-patterns P1, P1′ captured by the image capturing device 120 are different from one another when the normal direction N of the intersection point I of the flexible display D does not coincide with the receiving optical axis 120a of the image capturing device 120 (as shown in FIG. 1B). For instance, both of the two first dot-patterns P1, P1′ projected onto the intersection point I are oval-shaped. The major axis of the first dot-pattern P1 is longer than the major axis of the first dot-pattern P1′. In this embodiment, the two first dot-patterns P1, P1′ are circles, rectangles, polygons or other shapes. One ordinary skilled in the art may modify shape and size of the two first dot-patterns P1, P1′ based on design requirements.

To prevent both of the two first dot-patterns P1, P1′ from captured by the image capturing device 120 simultaneously, the two first collimated light sources 130a, 130b may project the first dot-pattern P1 and the first dot-pattern P1′ onto the intersection point I of the flexible display D sequentially. In this way, the image capturing device 120 can respectively capture the first dot-pattern P1 and the first dot-pattern P1′ at different time points. In a preferred embodiment, the two first collimated light sources 130a, 130b may project the first dot-pattern P1 and the first dot-pattern P1′ onto the intersection point I of the flexible display D alternately such that the image capturing device 120 can capture the first dot-pattern P1 and the first dot-pattern P1′ alternately, and positioning of the flexible display D is facilitated accordingly.

As shown in FIG. 1A and FIG. 1B, the OCC apparatus 100 of this embodiment may further include an inspection light source 140 mounted on the image capturing device 120. Specifically, when the normal direction N of the intersection point I of the flexible display D coincides with the receiving optical axis 120a of the image capturing device 120 (i.e. positioning of the flexible display D is accomplished), the two first collimated light sources 130a, 130b are turned-off and the inspection light source 140 is turned on. After the inspection light source 140 is turned on, the optical inspection of the flexible display D is performed.

### Second Embodiment

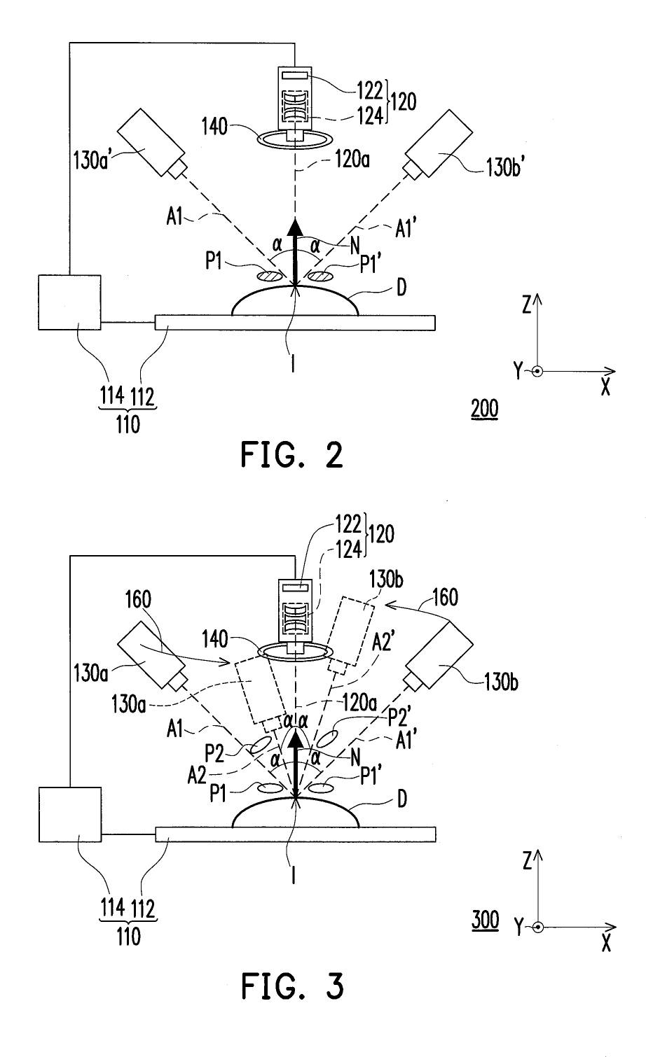

FIG. 2 is a schematic view illustrating an OCC apparatus according to the second embodiment of the application. Referring to FIG. 2, the OCC apparatus 200 of this embodiment is similar with the OCC apparatus 100 of the first embodiment except that the wavelength of light emitted from the two first collimated light sources 130a′, 130b′ are different from one another. In addition, the light with different wavelengths can be absorbed and identified by the image capturing device 120. For instance, the light emitted from the two first collimated light sources 130a′ is highly-collimated red light, and the light emitted from the two first collimated light sources 130b′ is highly-collimated green light.

One ordinary skilled in the art may modify wavelengths of the light emitted from the two first collimated light sources 130a′ and 130b′ based on design requirements.

Since the wavelengths of light emitted from the two first collimated light sources 130a′ and 130b′ are different from one another, the image capturing device 120 is capable of capturing and distinguishing the two first dot-patterns P1, P1′ at the same time even though the two first dot-patterns P1, P1′ are projected onto the intersection point I of the flexible display D simultaneously.

### The Third Embodiment

FIG. 3 is a schematic view illustrating an OCC apparatus according to the third embodiment of the application. Referring to FIG. 3, the OCC apparatus 300 of this embodiment is similar with the OCC apparatus 100 of the first embodiment except that the two first collimated light sources 130a, 130b are physically connected with a rotator 160. The rotator 160 drives the two first collimated light sources 130a, 130b to rotate around the receiving optical axis 120a, such that the two first collimated light sources 130a, 130b project two second dot-patterns P2, P2′ onto the intersection point I along two second optical paths A2, A2′ having identical length but different extending directions. An included angle between each of the two second optical paths A2, A2′ and the receiving optical axis 120a is an acute angle α. The two second optical paths A2, A2′ and the receiving optical axis 120a are located in a second virtual plane. In this embodiment, the above-mentioned second virtual plane is parallel with Y-Z plane.

In this embodiment, the rotator 160 drives the two first collimated light sources 130a, 130b to rotate about 90 degrees around the receiving optical axis 120a. In other words, the first virtual plane where the two first optical paths A1, A1′ are located is parallel to X-Z plane, the second virtual plane where the two second optical paths A2, A2′ are located is parallel to Y-Z plane, and the first virtual plane is perpendicular to the second virtual plane.

It is noted that each of the two first collimated light sources 130a, 130b is, for example, a visible light source with collimating lens or a pin-hole laser. In addition, the two first collimated light sources having different wavelengths can also be used in this embodiment.

### The Fourth Embodiment

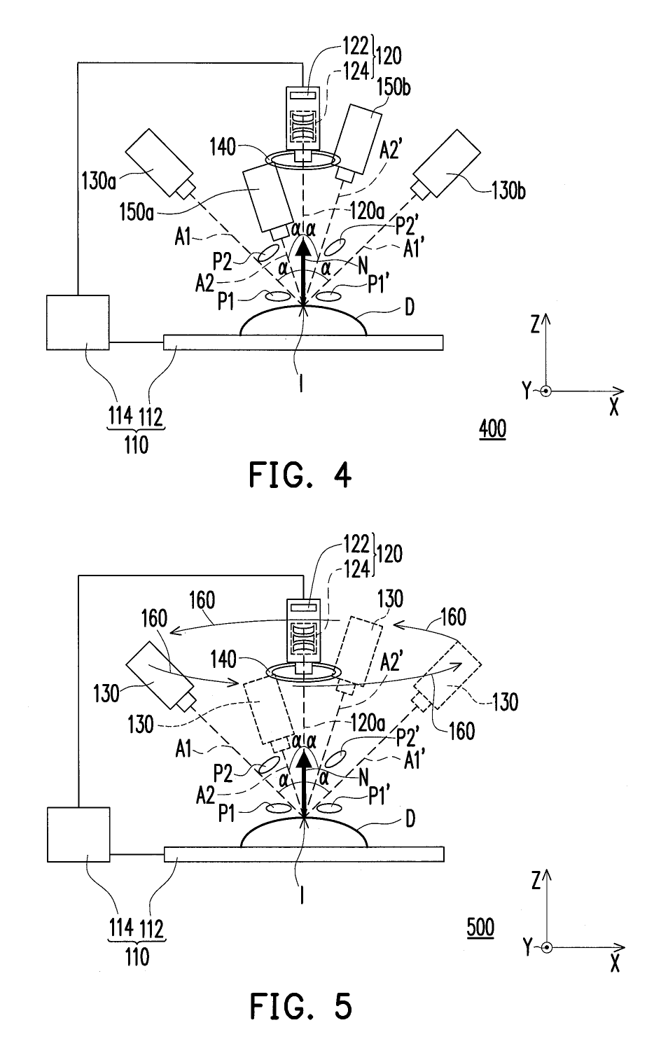

FIG. 4 is a schematic view illustrating an OCC apparatus according to the fourth embodiment of the application. Referring to FIG. 4, the OCC apparatus 400 of this embodiment is similar with the OCC apparatus 100 of the first embodiment except that the OCC apparatus 400 further includes two second collimated light sources 150a, 150b. The two second collimated light sources 150a, 150b project two second dot-patterns P2, P2′ onto the intersection point I along two second optical paths A2, A2′ having identical length but different extending directions. An included angle between each of the two second optical paths A2, A2′ and the receiving optical axis 120a is an acute angle α. The two second optical paths A2, A2′ and the receiving optical axis 120a are located in a second virtual plane that is parallel to Y-Z plane. In addition, the first virtual plane where the two first optical paths A1, A1′ are located is parallel to X-Z plane, the second virtual plane where the two second optical paths A2, A2′ are located is parallel to Y-Z plane, and the first virtual plane is perpendicular to the second virtual plane.

Thereafter, a normal direction N of the intersection point I is adjusted by the adjustable stage 110 until the two first dot-patterns P1, P1′ or the two second dot-patterns P2, P2′ projected onto the intersection point I are substantially identical.

It is noted that each of the two first collimated light sources 130a, 130b is, for example, a visible light source with collimating lens or a pin-hole laser. In addition, the two first collimated light sources having different wavelengths can also be used in this embodiment. Similarly, each of the two second collimated light sources 150a, 150b is, for example, a visible light source with collimating lens or a pin-hole laser. In addition, the two first collimated light sources having different wavelengths can also be used in this embodiment.

### The Fifth Embodiment

FIG. 5 is a schematic view illustrating an OCC apparatus according to the fifth embodiment of the application. Referring to FIG. 5, the OCC apparatus 500 of this embodiment is suitable for inspecting optical characteristics of a flexible display D. The OCC apparatus 500 including an adjustable stage 110, an image capturing device 120, a collimated light source 130 and a rotator 160. The adjustable stage 110 is suitable for carrying the flexible display D. The image capturing device 120 is disposed above the adjustable stage 110 and an intersection of a receiving optical axis 120a of the image capturing device 120 and the curved surface of the flexible display D is an intersection point I.

In this embodiment, the adjustable stage 110 includes a stage 112 and a controller 114, wherein the stage 112 is suitable for carrying the flexible display D, the controller 114 is electrically connected to the image capturing device 120 and the stage 112. The controller 114 controls the movement of the stage 112 until the two first dot-patterns P1′, P1′ projected onto the intersection point I and captured by the image capturing device 120 are substantially identical. In addition, the stage 112 is, for example, a six-axes rotatable stage.

The image capturing device 120 includes a photo-sensor 122 and a lens 124, wherein the lens 124 is between the photo-sensor 122 and the adjustable stage 110, and the receiving optical axis 120a of the image capturing device 120 is defined by the lens 124.

The rotator 160 is physically connected to the collimated light source 130 and drives the collimated light source 130 to rotate around the receiving optical axis 120a, such that the collimated light source 130 projects at least two first dot-patterns P1, P1′ onto the intersection point I along two first optical paths A1, A1′ having identical length but different extending directions. An included angle between each of the two first optical paths A1, A1′ and the receiving optical axis 120a is an acute angle α. The two first optical paths A1, A1′ and the receiving optical axis 120a are located in a first virtual plane that is parallel to X-Z plane. Thereafter, a normal direction N of the intersection point I is adjusted by the adjustable stage 110 until the two first dot-patterns P1, P1′ projected onto the intersection point I and captured by the image capturing device 120 are substantially identical.

Similarly, the rotator 160 may drives the collimated light source 130 to further rotate around the receiving optical axis 120a, such that the collimated light source 130 projects two second dot-patterns P2, P2′ onto the intersection point I along two second optical paths A2, A2′ having identical length but different extending directions. An included angle between each of the two second optical paths A2, A2′ and the receiving optical axis 120a is an acute angle α. The two second optical paths A2, A2′ and the receiving optical axis 120a are located in a second virtual plane that is parallel to Y-Z plane. Moreover, the normal direction N of the intersection point I of the flexible display D is adjusted by the adjustable stage 110 until the two second dot-patterns P2, P2′ projected onto the intersection point I and captured by the image capturing device 120 are substantially identical.

In addition, the first virtual plane where the two first optical paths A1, A1′ are located is parallel to X-Z plane, the second virtual plane where the two second optical paths A2, A2′ are located is parallel to Y-Z plane, and the first virtual plane is perpendicular to the second virtual plane.

In this disclosure, the OCC apparatus can inspect optical characteristics of flexible displays without considering the information regarding the outer profile of flexible display panels which is obtained from the CMM apparatus. Accordingly, the OCC apparatus of this disclosure can inspect optical characteristics of flexible displays rapidly.

Although the disclosure has been described with reference to the above embodiments, it will be apparent to one of the ordinary skill in the art that modifications to the described embodiment may be made without departing from the spirit of the disclosure. Accordingly, the scope of the disclosure will be defined by the attached claims not by the above detailed descriptions.

What is claimed is:

1. An optical characteristics capturing apparatus (OCC apparatus), comprising:
an adjustable stage for carrying a flexible display, wherein a part of the flexible display forms a curved surface;
an image capturing device disposed above the adjustable stage, wherein an intersection of a receiving optical axis of the image capturing device and the curved surface of the flexible display is an intersection point;
two first collimated light sources, the two first collimated light sources projecting two first dot-patterns onto the intersection point along two first optical paths having identical length but different extending directions, wherein an included angle between each of the two first optical paths and the receiving optical axis is an acute angle, and the two first optical paths and the receiving optical axis are located in a first virtual plane.

2. The OCC apparatus of claim 1, wherein the adjustable stage comprises:
a stage for carrying the flexible display; and
a controller electrically connected to the image capturing device and the stage, wherein the controller controls the movement of the stage until the two first dot-patterns captured by the image capturing device are substantially identical.

3. The OCC apparatus of claim 2, wherein the adjustable stage is a six-axes rotatable stage.

4. The OCC apparatus of claim 1, wherein the image capturing device comprises:
a photo-sensor; and
a lens disposed between the photo-sensor and the adjustable stage, wherein the receiving optical axis of the image capturing device is defined by the lens.

5. The OCC apparatus of claim 1, wherein each of the two first collimated light sources comprises a visible light source with a collimating lens.

6. The OCC apparatus of claim 1, wherein each of the two first collimated light sources comprises a pin-hole laser.

7. The OCC apparatus of claim 1, wherein wavelengths of light emitted from the two first collimated light sources are different from one another.

8. The OCC apparatus of claim 1 further comprising an inspection light source mounted on the image capturing device.

9. The OCC apparatus of claim 1 further comprising:
two second collimated light sources, the two second collimated light sources projecting two second dot-patterns onto the intersection point along two second optical paths having identical length but different extending directions, wherein an included angle between each of the two second optical paths and the receiving optical axis is an acute angle, the two second optical paths and the receiving optical axis are located in a second virtual plane, and the normal direction of the intersection point of the flexible display is adjusted by the adjustable stage until the two second dot-patterns captured by the image capturing device are substantially identical.

10. The OCC apparatus of claim 9, wherein the first virtual plane is perpendicular to the second virtual plane.

11. The OCC apparatus of claim 1 further comprising:
a rotator connected to the two first collimated light sources, wherein the rotator drives the two first collimated light sources to rotate around the receiving optical axis such that the two first collimated light sources projects two second dot-patterns onto the intersection point along two second optical paths having identical length but different extending directions, an included angle between each of the two first optical paths and the receiving optical axis is an acute angle, and the two first optical paths and the receiving optical axis are located in a second virtual plane.

12. The OCC apparatus of claim 11, wherein the first virtual plane is perpendicular to the second virtual plane.

13. An optical characteristics capturing apparatus (OCC apparatus), comprising:
an adjustable stage for carrying a flexible display, wherein a part of the flexible display forms a curved surface;
an image capturing device disposed above the adjustable stage, wherein an intersection of a receiving optical axis of the image capturing device and the curved surface of the flexible display is an intersection point;
a collimated light source;
a rotator connected to the collimated light source, wherein the rotator drives the collimated light source to rotate around the receiving optical axis, such that the collimated light source projects two first dot-patterns onto the intersection point along two first optical paths having identical length but different extending directions, an included angle between each of the two first optical paths and the receiving optical axis is an acute angle, and the two first optical paths and the receiving optical axis are located in a first virtual plane.

14. The OCC apparatus of claim 13, wherein the rotator drives the collimated light source to further rotate around the receiving optical axis such that the collimated light source projects two second dot-patterns onto the intersection point along two second optical paths having identical length but different extending directions, an included angle between each of the two second optical paths and the receiving optical axis is an acute angle, the two second optical paths and the receiving optical axis are located in a second virtual plane, and the normal direction of the intersection point of the flexible display is adjusted by the adjustable stage until the two second dot-patterns captured by the image capturing device are substantially identical.

15. The OCC apparatus of claim 14, wherein the first virtual plane is perpendicular to the second virtual plane.

16. The OCC apparatus of claim 13, wherein the adjustable stage comprises:
a stage for carrying the flexible display; and
a controller electrically connected to the image capturing device and the stage, wherein the controller controls the movement of the stage until the two first dot-patterns captured by the image capturing device are substantially identical.

17. The OCC apparatus of claim 16, wherein the adjustable stage is a six-axes rotatable stage.

18. The OCC apparatus of claim 13, wherein the image capturing device comprises:
a photo-sensor; and
a lens disposed between the photo-sensor and the adjustable stage, wherein the receiving optical axis of the image capturing device is defined by the lens.

19. The OCC apparatus of claim 13, wherein each of the two first collimated light sources comprises a visible light source with a collimating lens.

20. The OCC apparatus of claim 13, wherein each of the two first collimated light sources comprises a pin-hole laser.

21. The OCC apparatus of claim 13, wherein wavelengths of light emitted from the two first collimated light sources are different from one another.

22. The OCC apparatus of claim 13 further comprising an inspection light source mounted on the image capturing device.

23. A method for inspecting optical characteristics of a flexible display, comprising:
disposing a flexible display above an adjustable stage, wherein a part of the flexible display forms a curved surface;
providing an image capturing device and two first collimated light sources, wherein the image capturing device is disposed above the adjustable stage and an intersection of a receiving optical axis of the image capturing device and the curved surface of the flexible display is an intersection point, the two first collimated light sources project two first dot-patterns onto the intersection point along two first optical paths having identical length but different extending directions, and the two first optical paths and the receiving optical axis are located in a first virtual plane.
adjusting a normal direction of the intersection point by the adjustable stage until the two first dot-patterns captured by the image capturing device are substantially identical.

24. The method of claim 23 further comprising:
providing two second collimated light sources, the two second collimated light sources projecting two second dot-patterns onto the intersection point along two second optical paths having identical length but different extending directions, wherein an included angle between each of the two second optical paths and the receiving optical axis is an acute angle, and the two second optical paths and the receiving optical axis are located in a second virtual plane.
adjusting the normal direction of the intersection point by the adjustable stage until the two second dot-patterns captured by the image capturing device are substantially identical.

25. The method of claim 24, wherein the first virtual plane is perpendicular to the second virtual plane.

26. The method of claim 23 further comprising:
providing a rotator connected to the two first collimated light sources;
driving the two first collimated light sources to rotate around the receiving optical axis by the rotator such that the two first collimated light sources project two second dot-patterns onto the intersection point along two second optical paths having identical length but different extending directions, an included angle between each of the two second optical paths and the receiving optical axis is an acute angle, and the two second optical paths and the receiving optical axis are located in a second virtual plane.

27. The OCC apparatus of claim 26, wherein the first virtual plane is perpendicular to the second virtual plane.
